(19) United States
(12) Patent Application Publication
(10) Pub. No.: US 2008/0229546 A1
(43) Pub. Date: Sep. 25, 2008

(54) POSITION HINGE

(75) Inventor: Chia-Ko Chung, Shulin City (TW)

Correspondence Address: PAI PATENT & TRADEMARK LAW FIRM, 1001 FOURTH AVENUE, SUITE 3200, SEATTLE, WA, 98154, US

(73) Assignee: SHIN ZU SHING CO., LTD., Shulin City (TW)

(21) Appl. No.: 11/690,828

(22) Filed: Mar. 25, 2007

(51) Int. Cl. E05D 7/00

(52) U.S. Cl. 16/380

(57) ABSTRACT

A position hinge has a pintle having an enlarged head, an inner bracket mounted securely around the pintle, an outer bracket mounted rotatably around the pintle, a positioning assembly mounted around the pintle and having an outer positioning member abutting and rotating simultaneously with an inner side of the outer bracket and an inner positioning member selectively engaging with the outer positioning member, a resilient element mounted between the inner positioning member and the inner bracket and a spacer assembly mounted between the outer bracket and the enlarged head of the pintle and rotating simultaneously with the outer bracket. Because the spacer assembly is mounted between the outer bracket and the enlarged of the pintle and rotates simultaneously with the outer bracket, the outer bracket is protected from being worn off by the enlarged head of the pintle and has a longer life span.

### BACKGROUND OF THE INVENTION

1. Field of the Invention

The present invention relates to a position hinge, and more particularly to a position hinge with a low friction and that has a longer life span.

2. Description of Related Art

A position hinge is mounted between two elements to allow a relative pivot between the two elements and to position the elements at an angle. For example, a position hinge is generally mounted between a body and a cover of an electronic merchandise, e.g. a notebook, a mobile phone, an electronic dictionary or the like, such that the cover can be pivoted to open or close relative to the body.

A conventional position hinge in accordance with the prior art is mounted in an electronic merchandise. The electronic merchandise has a body, a cover and a screen mounted on the cover. The position hinge is connected between the body and the cover and has a pintle, an inner bracket, an outer bracket, a positioning assembly and a nut.

The pintle has a non-circular cross-section, two opposite ends, an enlarged head and an outer thread. The enlarged head is formed on a first end of the pintle. The outer thread is formed on a second end of the pintle. The inner bracket is disposed in the body of the electronic merchandise and has a non-circular limiting hole. The limiting hole is formed through the inner bracket, corresponds to the non-circular cross-section of the pintle and is mounted securely around the pintle.

The outer bracket is disposed in the cover of the electronic merchandise, abuts against the enlarged head of the pintle and has a mounting hole and a positioning hole. The mounting hole is formed through the outer bracket and is mounted rotatably around the pintle so that the outer bracket can rotate relative to the inner bracket. The positioning hole is formed through the outer bracket near the mounting hole in the outer bracket.

The positioning assembly is mounted around the pintle between the inner bracket and the outer bracket and has a female positioning member and a male positioning member.

The female positioning member has two opposite sides, a mounting hole, at least one cutout and a positioning rod. The mounting hole is formed through the female positioning member and is mounted rotatably around the pintle. The at least one cutout is formed in a first side of the female positioning member around the mounting hole in the female positioning member. The positioning rod is formed on and protrudes from a second side of the female positioning member near the mounting hole in the female positioning member and inserts into the positioning hole in the outer bracket. Thus, the female positioning member can rotate simultaneously with the outer bracket.

The male positioning member has two opposite sides, a non-circular limiting hole and at least one protrusion. The non-circular limiting hole is formed through the male positioning member, corresponds to the non-circular cross-section and is mounted securely around the pintle. The at least one protrusion is formed on and protrudes from a first side of the male positioning member and respectively engages with the at least one cutout of the female positioning member.

When the cover is pivoted, the pintle rotates simultaneously with the cover and drives the male positioning member to rotate relative to the female positioning member. When the cover is in an open position, the at least one protrusion of the male positioning member does not align with the at least one cutout of the female positioning member, so that the male positioning member and the female positioning member are respectively pressed against the inner bracket and the outer bracket to provide enough static friction to retain the cover at a desired open angle. When the cover is in a closed position, the at least one protrusion engages with the at least one cutout to prevent the cover from being unintentionally opened.

The nut is screwed onto the outer thread on the second end of the pintle to securely hold the inner bracket, outer bracket, male positioning member and female positioning member on the pintle against the enlarged head of the pintle.

However, because the outer bracket abuts against the enlarged head of the pintle, when the outer bracket rotates relative to the pintle, an acute friction occurs between the outer bracket and the enlarged head of the pintle. Thus, after a long time of use, the outer bracket will be severely worn off and become thinner. Accordingly, even though the at least one protrusion is offset relative to the at least one cutout, the male positioning member and the female positioning member can not be strongly pressed against the inner bracket and the outer bracket and are unable to cause an enough static friction to retain the cover at an expected open angle.

### SUMMARY OF THE INVENTION

The primary objective of the present invention is to provide a position hinge to mitigate or obviate the aforementioned problem of the conventional hinge.

A position hinge in accordance with the present invention has a pintle having an enlarged head formed on an outer end of the pintle, an inner bracket having a limiting hole mounted securely around the pintle, an outer bracket having a mounting hole mounted rotatably around the pintle, a positioning assembly mounted around the pintle between the outer bracket and the inner bracket and having an outer positioning member abutting an inner side of the outer bracket and rotating simultaneously with the outer bracket and an inner positioning member selectively engaging with the outer positioning member, a resilient element mounted between the inner positioning member and the inner bracket, a spacer assembly mounted between the outer bracket and the enlarged head of the pintle and rotating simultaneously with the outer bracket and a fastener mounted around the pintle to securely hold the resilient element, the positioning assembly, the outer bracket and the spacer assembly on the pintle.

Because the spacer assembly is mounted between the outer bracket and the enlarged of the pintle, the outer bracket is protected from being worn off by the enlarged head of the pintle. Additionally, the outer positioning member and the spacer assembly respectively abut two sides of the outer bracket and rotate simultaneously with the outer bracket, so the outer bracket are protected from being worn off by the enlarged head of the pintle. Accordingly, the outer bracket has a longer life span.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a position hinge in accordance with the present invention;

FIG. 2 is an exploded perspective view of the position hinge in FIG. 1;

FIG. 3 is a side view of the position hinge in FIG. 1; and

FIG. 4 is an enlarged operational side view of the position hinge in FIG. 1.

### DETAILED DESCRIPTION OF THE PREFERRED EMBODIMENT

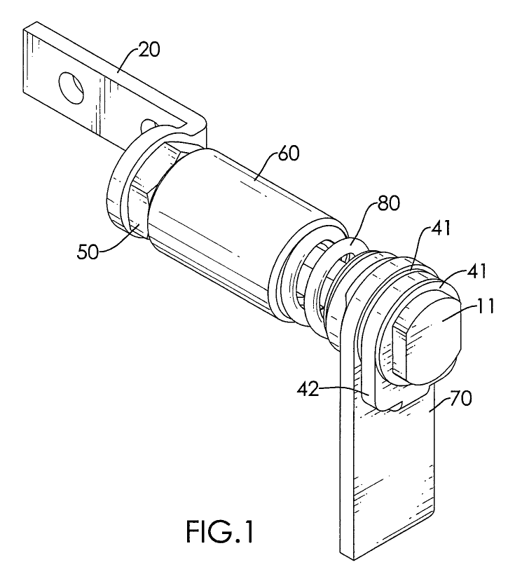

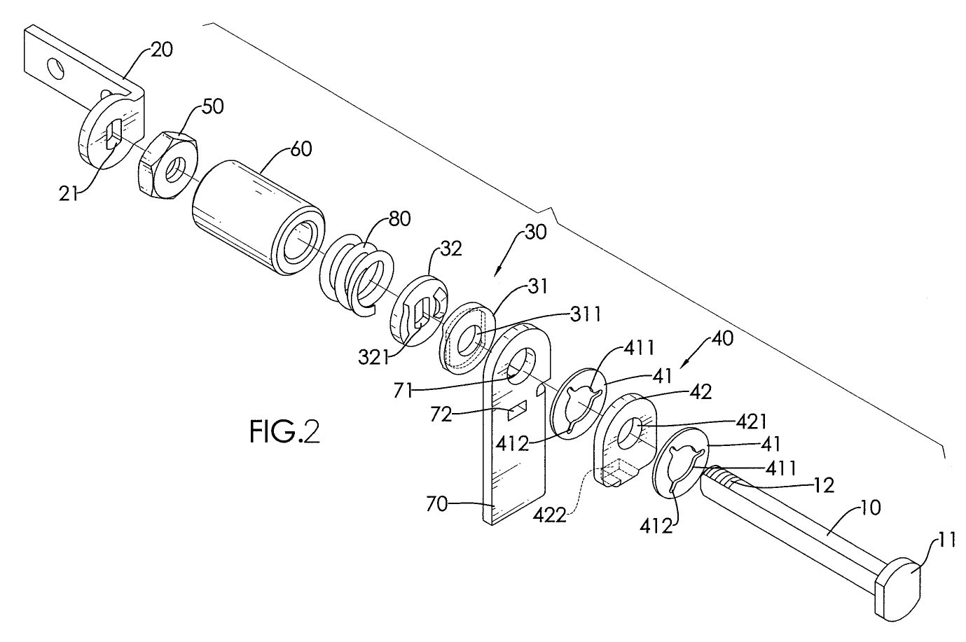

With reference to FIGS. 1 to 3, a position hinge in accordance with the present invention is adapted to be mounted in an electronic merchandise, e.g. a notebook, a mobile phone, an electronic dictionary or the like. The electronic merchandise has a body, a cover and a screen mounted on the cover. The position hinge is connected between the body and the cover and has a pintle (10), an inner bracket (20), an outer bracket (70), a positioning assembly (30), a resilient element (80), a spacer assembly (40), a fastener (50) and a sleeve (60).

The pintle (10) has a cross-section, an outer end, an inner end, an enlarged head (11) and an outer thread (12). The cross-section of the pintle (10) may be non-circular. The enlarged head (11) is formed on the outer end of the pintle (10). The outer thread (12) is formed on the inner end of the pintle (10).

The inner bracket (20) is adapted to be mounted in the body of the electronic merchandise and has a limiting hole (21). The limiting hole (21) is formed through the inner bracket (20) and is mounted securely around the pintle (10). The limiting hole (21) may be non-circular and corresponds to the cross-section of the pintle (10) to mount the inner bracket (20) securely on the pintle (10). Further, the inner end of the pintle may be expanded with an impacting manner after the inner bracket (20) is mounted on the pintle (10) to prevent the inner bracket (20) from detaching from the pintle (10).

The outer bracket (70) is adapted to be mounted in the cover of the electronic merchandise and has a mounting hole (71) and a mounting recess (72). The mounting hole (71) is formed through the outer bracket (70) and is mounted rotatably around the pintle (10) so that the outer bracket (70) can rotate relative to the inner bracket (20). The mounting recess (72) is formed through the outer bracket (70) near the mounting hole (71) in the outer bracket (70).

The positioning assembly (30) is mounted around the pintle (10) between the inner bracket (20) and the outer bracket (70) and has an outer positioning member (31) and an inner positioning member (32).

The outer positioning member (31) has an outer side, an inner side, a mounting hole (311) and at least one first engaging portion (312). The outer side abuts against the outer bracket (70). The mounting hole (311) is formed through the outer positioning member (31) and is mounted rotatably around the pintle (10). The at least one first engaging portion (312) is formed on the inner side of the outer positioning member (31) around the mounting hole (311) in the outer positioning member (31), and each of the at least one first engaging portion (312) may be a cutout formed in the inner side of the outer positioning member (31). The outer positioning member (31) is driven to rotate simultaneously with the outer bracket (70) by the friction between the outer side of the outer positioning member (31) and the outer bracket (70).

The inner positioning member (32) has an outer side, an inner side, a limiting hole (321) and at least one second engaging portion (322). The limiting hole (321) is formed through the inner positioning member (32) and is mounted securely around the pintle (10). The limiting hole (321) may be non-circular and correspond to the cross-section of the pintle (10) to mount the inner positioning member (32) securely on the pintle (10). The at least one second engaging portion (322) is formed on the outer side of the inner positioning member (32) and respectively engages with the at least one first engaging portion (312) of the outer positioning member (70). Each of the at least one second engaging portion (322) may be a protrusion formed on and protruding from the outer side of the inner positioning member (32).

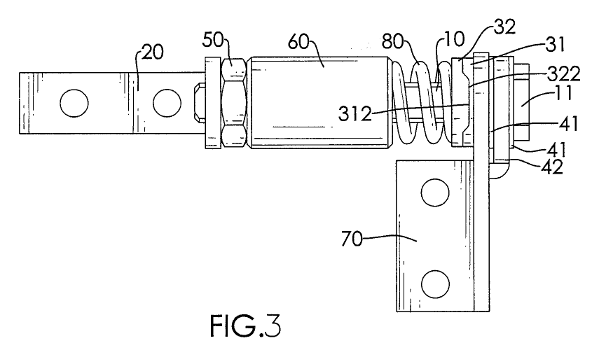

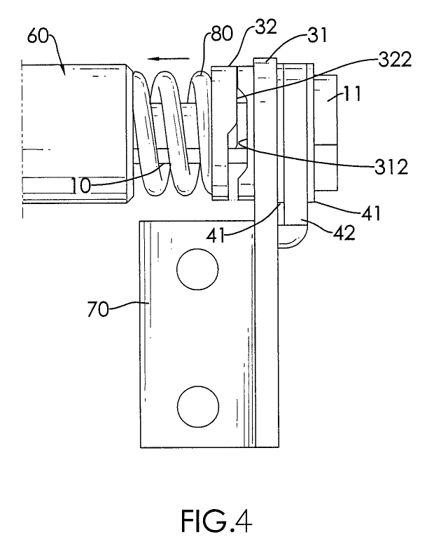

When the cover is pivoted, the pintle (10) rotates simultaneously with the cover and drives the outer positioning member (70) to rotate relative to the inner positioning member (20). With reference to FIG. 4, when the cover is at an open position, the at least one first engaging portion (312) of the outer positioning member (31) does not align with the at least one second engaging portion (322) of the inner positioning member (32), so that the outer positioning member (31) and the inner positioning member (32) are respectively pressed toward the outer bracket (70) and the inner bracket (20) to provide enough static friction to retain the cover at a desired open angle. With reference to FIG. 3, when the cover is at a closed position, the at least one first engaging portion (312) engages with the second engaging portion (322) to prevent the cover from being unintentionally opened.

The resilient element (80) is mounted between the inner positioning member (32) and the inner bracket (20) to be compressed by the inner positioning member (32) when the at least one second positioning member (322) of the inner positioning member (32) is offset relative to the at least one first positioning member (312) of the outer positioning member (31). The resilient element (80) may be a spring mounted around the pintle (10).

The spacer assembly (40) is mounted between the outer bracket (70) and the enlarged head (11) of the pintle (10) and has a securing member (42) and two spacers (411).

The securing member (42) has two opposite sides, a mounting hole (421) and a mounting lug (422). The mounting hole (421) is formed through the securing member (42) and is mounted rotatably around the pintle (10). The mounting lug (422) is form on and protrudes from the securing member (42) near the mounting hole (421) in the securing member (42) and inserts into the mounting recess (72) in the outer bracket (70) to firmly prevent relative rotation between the securing member (42) and the outer bracket (70).

The spacers (41) are respectively mounted on the two sides of the securing member (42), and each spacer (41) has a through hole (411) and multiple gaps (411). The through hole (411) is formed through the spacer (41) and is mounted rotatably around the pintle (10) and has a circumferential edge. The gaps (411) are formed in the circumferential edge of the through hole (411) in the spacer (41) at intervals, such that the spacer (41) is prevented from excessive deformation when being compressed.

An inner spacer (41) is driven to rotate simultaneously with the outer bracket (70) by the friction between the inner spacer (41) and the outer bracket (70). The friction between the spacers (41) and the securing member (42) drives the securing member (42) to rotate simultaneously with the spacers (41). When the at least one first engaging portion (312) of the outer positioning member (31) is offset relative to the at least one second engaging portion (322) of the inner positioning member (32), the spacers (42) and the securing member (42) are compressed more tightly to provide more friction for firmly hold the cover at a desired open angle.

The fastener (50) is mounted around the pintle (10) to securely hold the resilient element (80), the positioning assembly (30), the outer bracket (70) and the spacer assembly (40) on the pintle (10) against the enlarged head (11) of the pintle (10). The fastener (50) may be a nut screwed onto the outer thread (12) on the inner end of the pintle (10).

The fastener (50) provides an axial compressive force to press the outer positioning member (31), the outer bracket (70) and the spacer assembly (40) together, and the axial compressive acts as a normal force to cause potential strong static friction between each two elements of the outer positioning member (31), the outer bracket (70) and the spacer assembly (40). When the pintle (10) rotates, a torque is exerted on the inner positioning member (32) and causes a reactive axial force between the engaged at least one first engaging portion (312) and at least one second engaging portion (322).

A magnitude of the reactive axial force depends on that of the torque exerted on the inner positioning member (32). In operation, until the reactive axial force is larger than a stretching force of the resilient element (80), the torque is still smaller than the friction between any two elements of the outer positioning member (31), the outer bracket (70) and the spacer assembly (40) and is unable to drive the outer positioning member (31) to rotate simultaneously with the inner positioning member (32).

Accordingly, the outer positioning member (31), the outer bracket (70) and the spacer assembly (40) are always rotate simultaneously. When the pintle (10) rotates, the inner positioning member (32) are pressed to compress the resilient element (80) by the offset at least one second engaging portion (322) and at least one first engaging portion (312).

Additionally, because the difference of material, a static friction coefficient between an outer spacer (41) and the enlarged head (11) of the pintle (10) is smaller than that between each two elements of the outer positioning member (31), the outer bracket (70) and the spacer assembly (40). Thus, when the pintle (10) is driven to rotate by a torque larger than the friction between the outer spacer (41) and the enlarged head (11), the torque is still smaller than the friction between each two elements of the outer positioning member (31), the outer bracket (70) and the spacer assembly (40) and is unable to drive the outer spacer (11) to rotate simultaneously with the pintle (10).

Further, because the outer positioning member (31) and the spacer 19 assembly (40) rotate simultaneously with the outer bracket (70), so the outer bracket (70) is protected from being worn off by relative rotation of the outer positioning member (31) and the spacer assembly (40). Consequently, the outer bracket (70) has a longer life span.

The sleeve (60) is mounted around the pintle (10) between the resilient element (80) and the fastener (50) so that the pintle (10) can be stably received in the sleeve (60) to be rotated at a stationary axle.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A position hinge comprising:
a pintle having
a cross-section;
an outer end;
an inner end; and
an enlarged head formed on the outer end of the pintle;
an inner bracket having
a limiting hole formed through the inner bracket and mounted securely around the pintle;
an outer bracket having
a mounting hole formed through the outer bracket and mounted rotatably around the pintle;
a positioning assembly mounted around the pintle between the inner bracket and the outer bracket and having
an outer positioning member having
an outer side abutting against the outer bracket;
an inner side;
a mounting hole formed through the outer positioning member and mounted rotatably around the pintle; and
at least one first engaging portion formed on the inner side of the outer positioning member around the mounting hole in the outer positioning member; and
an inner positioning member having
an outer side;
an inner side;
a limiting hole formed through the inner positioning member and mounted securely around the pintle; and
at least one second engaging portion formed on the outer side of the inner positioning member and respectively engaging with the at least one first engaging portion of the outer positioning member;
a resilient element mounted between the inner positioning member and the inner bracket;
a spacer assembly mounted between the outer bracket and the enlarged head of the pintle and having
a securing member having
two opposite sides; and
a mounting hole formed through the securing member and mounted rotatably around the pintle; and
two spacers respectively mounted on the opposite sides of the securing member, and each spacer having
a through hole formed through the spacer and mounted rotatably around the pintle and having a circumferential edge; and
multiple gaps formed in the circumferential edge of the through hole in the spacer at intervals; and
a fastener mounted around the pintle to securely hold the resilient element, the positioning assembly, the outer bracket and the spacer assembly on the pintle.

2. The position hinge as claimed in claim 1, wherein
the cross-section of the pintle is non-circular;
the limiting hole in the inner bracket is non-circular and corresponds to the cross-section of the pintle; and
the limiting hole in the inner positioning member is non-circular and corresponds to the cross-section of the pintle.

3. The position hinge as claimed in claim 1, wherein
the pintle further has an outer thread formed on the inner end of the pintle; and
the fastener is a nut screwed onto the outer thread on the inner end of the pintle.

4. The position hinge as claimed in claim 1, wherein
each one of the at least one first engaging portion is a cutout formed in the inner side of the outer positioning member; and
each one of the at least one second engaging portion is a protrusion formed on and protruding from the outer side of the inner positioning member.

5. A position hinge comprising:
a pintle having
a cross-section;
an outer end;
an inner end; and
an enlarged head formed on the outer end of the pintle;
an inner bracket having
a limiting hole formed through the inner bracket and mounted securely around the pintle;
an outer bracket having
a mounting hole formed through the outer bracket and mounted rotatably around the pintle; and
a mounting recess formed through the outer bracket near the mounting hole in the outer bracket;
a positioning assembly mounted around the pintle between the inner bracket and the outer bracket and having
an outer positioning member having
an outer side abutting against the outer bracket;
an inner side;
a mounting hole formed through the outer positioning member and mounted rotatably around the pintle; and
at least one first engaging portion formed on the inner side of the outer positioning member around the mounting hole in the outer positioning member; and
an inner positioning member having
an outer side;
an inner side;
a limiting hole formed through the inner positioning member and mounted securely around the pintle; and
at least one second engaging portion formed on the outer side of the inner positioning member and respectively engaging with the at least one first engaging portion of the outer positioning member;
a resilient element mounted between the inner positioning member and the inner bracket;
a spacer assembly mounted between the outer bracket and the enlarged head of the pintle and having
a securing member having
two opposite sides;
a mounting hole formed through the securing member and mounted rotatably around the pintle; and
a mounting lug formed on and protruding from the securing member near the mounting hole in the securing member and inserting into the mounting recess in the outer bracket; and
two spacers respectively mounted on the opposite sides of the securing member, and each spacer having
a through hole formed through the spacer and mounted rotatably around the pintle and having a circumferential edge; and
a fastener mounted around the pintle to securely hold the resilient element, the positioning assembly, the outer bracket and the spacer assembly on the pintle.

6. The position hinge as claimed in claim 1, wherein the resilient element is a spring mounted around the pintle.

7. A position hinge comprising:
a pintle having
a cross-section;
an outer end;
an inner end; and
an enlarged head formed on the outer end of the pintle;
an inner bracket having
a limiting hole formed through the inner bracket and mounted securely around the pintle;
an outer bracket having
a mounting hole formed through the outer bracket and mounted rotatably around the pintle;
a positioning assembly mounted around the pintle between the inner bracket and the outer bracket and having
an outer positioning member having
an outer side abutting against the outer bracket;
an inner side;
a mounting hole formed through the outer positioning member and mounted rotatably around the pintle; and
at least one first engaging portion formed on the inner side of the outer positioning member around the mounting hole in the outer positioning member; and
an inner positioning member having
an outer side;
an inner side;
a limiting hole formed through the inner positioning member and mounted securely around the pintle; and
at least one second engaging portion formed on the outer side of the inner positioning member and respectively engaging with the at least one first engaging portion of the outer positioning member;
a resilient element mounted between the inner positioning member and the inner bracket;
a spacer assembly mounted between the outer bracket and the enlarged head of the pintle and having
a securing member having
two opposite sides; and
a mounting hole formed through the securing member and mounted rotatably around the pintle; and
two spacers respectively mounted on the opposite sides of the securing member, and each spacer having
a through hole formed through the spacer and mounted rotatably around the pintle and having a circumferential edge;
a fastener mounted around the pintle to securely hold the resilient element, the positioning assembly, the outer bracket and the spacer assembly on the pintle; and
a sleeve mounted around the pintle between the resilient element and the fastener.

8. (canceled)
